(19) United States
(12) Patent Application Publication
(10) Pub. No.: US 2025/0064018 A1
(43) Pub. Date: Feb. 27, 2025

(54) IMPROVEMENTS IN ELECTRONIC IDENTIFICATION TAG READER SYSTEMS

(71) Applicant: ALLFLEX AUSTRALIA PTY. LTD., Queensland (AU)

(72) Inventors: Benjamin Thomas John WILKINSON, Redland Bay (AU); Leigh Andrew BATEMAN, Brendale (AU); Brian Antony CLAYTON, Queensland (AU)

(73) Assignee: ALLFLEX AUSTRALIA PTY. LTD., Queensland (AU)

(21) Appl. No.: 18/721,438

(22) PCT Filed: Dec. 23, 2022
(86) PCT No.: PCT/AU2022/051579

§ 371 Date: Jun. 18, 2024

(30) Foreign Application Priority Data
Dec. 24, 2021 (AU) 2021904264

(51) Int. Cl. A01K 11/00; G06K 7/10

(52) U.S. Cl. CPC A01K 11/006; A01K 11/004; G06K 7/10356; G06K 7/10435

(57) ABSTRACT

A reader for an electronic identification tag, the reader comprising: a transmitter antenna for exciting a passive electronic identification tag in proximity, the transmitter antenna comprising one or more single windings; and a receiver antenna for coupling a signal from the electronic identification tag to other parts 5 of a receiver module, the antenna comprising twin windings wound in an anti-phase manner. A method for identifying a sequence of unique identifiers, each unique identifier being associated with an animal, the method comprising: obtaining a stream of reads from animal identification tags, each animal identification tag being attached to a corresponding animal, each read comprising 10 one of a plurality of unique identifiers; identifying one or more distributions based on the number of reads for each of the plurality of unique identifiers in the stream; and determining a sequence of unique identifiers based on the distributions.

### FIELD

This invention relates to improvements in electronic identification tag reader systems.

### BACKGROUND

Electronic identification tags are used to identify objects. These objects may be travelling in a facility, moving around in an open space, or some combination. As used herein, a facility simply refers to a space configured for a function, and it may be indoor, outdoor, or some combination. In one example, the objects may be moving along paths, which may be defined as described herein. An electronic identification tag comprises an identifier for an object which can be used to identify that object as distinct from other objects in the same set. As the objects move, one or more readers can read the tags associated with the objects. The identifiers, once read, can then be used, transferred, and/or stored.

In a first example, the objects may be live animals moving through an area such as a facility, (which may be indoor or outdoor, such as a slaughterhouse, abattoir, feedlot, farm, barn, field, pasture, paddock, etc.). Readers can be provided at one or more locations in the facility. For example, the locations may include one or more of a race, a gate, a feeding area, a milking area, or checkpoints or locations that animals may pass or congregate near. In some cases, the facility may comprise one or more races. In one example, the facility may have paths. The paths may be defined by the construction or layout of the facility. In one example, the paths may be defined by the races, or in the case where a race splits, multiple paths maybe be defined in this manner. Readers are provided at one or more points in the facility. For example, these may be provided along each race.

Each animal is provided with one or more electronic animal identification tags. Such a tag may be attached to the animal's ear, embedded in the animal's skin, fat, or muscle, sit within the animal's rumen, or is otherwise associated with the animal. Multiple tags may be provided for the same animal. Each tag may have the same identifier or different tags may have different identifiers. As each animal moves through and about the facility, readers read the electronic animal identification tag associated with the animal.

In a second example, the objects may be animal carcasses moving through an abattoir or slaughterhouse comprising one or more moving lines. Each line has a series of hooks to which an animal carcass may be attached. The lines are typically motorised, so that the hooks travel along the line when the line is switched on. Each line defines a path, or in the case where a line splits, multiple paths. When a carcass is attached to a hook, the carcass consequently follows the path defined by the line.

Each carcass is provided with one or more electronic animal identification tags, which may be the same one or more electronic animal identification tags that were attached to the corresponding live animal. Such a tag may be attached to the ear, embedded in the skin, fat, or muscle, sit within the rumen, or is otherwise associated with the carcass. Multiple tags may be provided for the same carcass. In these cases, each tag may have the same identifier or different tags may have different identifiers. As each carcass moves through the facility, readers read the electronic animal identification tag associated with the carcass.

In a third example, the objects may be items moving through a factory, warehouse, or similar facility. The facility may have one or more lines or routes, which may comprise a conveyor belt, a series of hooks, or any other mechanisms that convey objects. The factory may have multiple different types of lines in use, and each line may carry a different type of item, the same types of items, or a combination. The lines are typically motorised, so that the objects are conveyed along the line when the line is switched on.

Each object is provided with an electronic identification tag. This may be attached to the surface of the object or embedded within the object. In some cases, a single item may have multiple electronic identification tags. For example, an item may be composed of multiple components, where each component has its own electronic identification tag. As each object moves through the facility, readers read the electronic identification tag associated with the object.

In a fourth example, the objects may be mined material, such as rocks, minerals, or ore. Electronic identification tags can be encoded with identification information (such as a unique identifier), information about provenance (such as where in a mine the ore was obtained) and information about contents (such as the grade of the ore). The material with the electronic identification tag can then be moved via scoops, trucks, conveyors, or elevators, along predetermined travel paths and/or through processing steps (such as crushing or sorting). As the ore moves through the facility, readers read the electronic identification tag associated with the material.

Electronic animal identification tags can be used to identify animals. An identification tag is securely attached to an animal, often to the animal's ear. By reading the tag, the animal can be uniquely identified. Readers in a facility can track and record animals as they move through the facility.

In each case, the electronic identification tag comprises an electronic component configured to be read by a corresponding reader. In one example, the electronic identification tag may be an active or passive radio frequency identification device (RFID). In another example, the electronic identification tag may be a Bluetooth low energy beacon. In further examples, any technology which allows for signal-based transmission of electronic identification information without line-of-sight may be used.

### SUMMARY

In a first example embodiment, there is provided a reader for an electronic identification tag, the reader comprising: a transmitter antenna for exciting a passive electronic identification tag in proximity, the transmitter antenna comprising one or more windings; and a receiver antenna for coupling a signal from the electronic identification tag to other parts of a receiver module, the antenna comprising twin windings wound in an anti-phase manner.

In a second example embodiment, there is provided the reader of the first example embodiment, wherein the transmitter antenna and the receiver antenna are positioned substantially perpendicular to one another.

In a third example embodiment, there is provided the reader of the second example embodiment, wherein the transmitter antenna and the receiver antenna are perpendicular within a tolerance of ±5°.

In a fourth example embodiment, there is provided the reader of any one of the first to third example embodiments, wherein the twin windings are configured to cause a reduction of the interference coupled into the received antenna.

In a fifth example embodiment, there is provided the reader of any one of the first to fourth example embodiments, wherein the transmitter antenna is enclosed in a panel.

In a sixth example embodiment, there is provided the reader of any one of the first to fifth example embodiments, wherein the receiver antenna is enclosed in a panel.

In a seventh example embodiment, there is provided the reader of any one of the first to sixth example embodiments, wherein the electronic identification tag is affixed to an animal, and the system is used for animal identification.

In an eighth example embodiment, there is provided a method for identifying a sequence of unique identifiers, each unique identifier being associated with an animal, the method comprising: obtaining a stream of reads from animal identification tags, each animal identification tag being attached to a corresponding animal, each read comprising one of a plurality of unique identifiers; identifying one or more distributions based on the number of reads for each of the plurality of unique identifiers in the stream; and determining a sequence of unique identifiers based on the distributions.

In a ninth example embodiment, there is provided the method of the eighth example embodiment, further comprising: generating one or more substreams from the stream, each substream comprising one or more successive reads.

In a tenth example embodiment, there is provided the method of the ninth example embodiment, wherein identifying one or more distributions based on the number of reads for each of the plurality of unique identifiers in the stream comprises: identifying one or more distributions based on the number of reads for each of the plurality of unique identifiers in each substream.

In an eleventh example embodiment, there is provided the method of any one of the eighth to tenth example embodiments, wherein the stream of reads is pseudo-random.

In a twelfth example embodiment, there is provided the method of any one of the eighth to eleventh example embodiments, wherein the distribution comprises a normal distribution.

In a thirteenth example embodiment, there is provided the method of any one of the eighth to twelfth example embodiments, wherein the distribution is substantially symmetric about a peak between a rise portion and a fall portion.

In a fourteenth example embodiment, there is provided the method of any one of the eighth to thirteenth example embodiments, further comprising: calculating a time for each unique identifier based on a peak of the distribution.

In a fifteenth example embodiment, there is provided the method of any one of the eighth to fourteenth example embodiments, further comprising: generating a visualisation corresponding to the one or more distributions.

In a sixteenth example embodiment, there is provided a method for operating an animal identification tag reader, the method comprising: determining, using a first sensor, that an animal bearer is approaching a reader; and determining, using a second sensor near the reader, whether an animal is attached to the animal bearer.

In a seventeenth example embodiment, there is provided the method of the sixteenth example embodiment, further comprising, in response to determining, using a first sensor, that an animal bearer is approaching a reader: attempting to read, using the reader, an identifier from an animal identification tag attached to the animal.

In an eighteenth example embodiment, there is provided the method of the seventeenth example embodiment, further comprising: determining, using a second sensor near the reader, that an animal is not attached to the animal bearer; and discarding a read from the reader.

In a nineteenth example embodiment, there is provided the method of the seventeenth example embodiment, further comprising: determining, using a second sensor near the reader, that an animal is attached to the animal bearer; and determining that the attempt to read failed.

In a twentieth example embodiment, there is provided the method of the nineteenth example embodiment, further comprising: in response to determining that the attempt to read failed: stopping further progress of the animal bearer.

In a twenty-first example embodiment, there is provided a method of operating an animal identification tag reader, the method comprising: determining a plurality of cadences; and reading one or more animal identification tags according to each of the plurality of cadences.

In a twenty-second example embodiment, there is provided the method of the twenty-first example embodiment, wherein determining a plurality of cadences comprises randomly determining a plurality of cadences.

In a twenty-third example embodiment, there is provided the method of the twenty-first or twenty-second example embodiment, wherein the net variation in the plurality of cadences relative to a predetermined cadence is approximately zero.

In a twenty-fourth example embodiment, there is provided the method of any one of the twenty-first to twenty-third example embodiments, wherein the plurality of cadences comprises a cadence calculated based on a mains frequency.

In a twenty-fifth example embodiment, there is provided the method of the twenty-fourth example embodiment, wherein the cadence calculated based on a mains frequency is not synchronised with the mains frequency.

### BRIEF DESCRIPTION

The description is framed by way of example with reference to the drawings which show certain embodiments. However, these drawings are provided for illustration only, and do not exhaustively set out all embodiments.

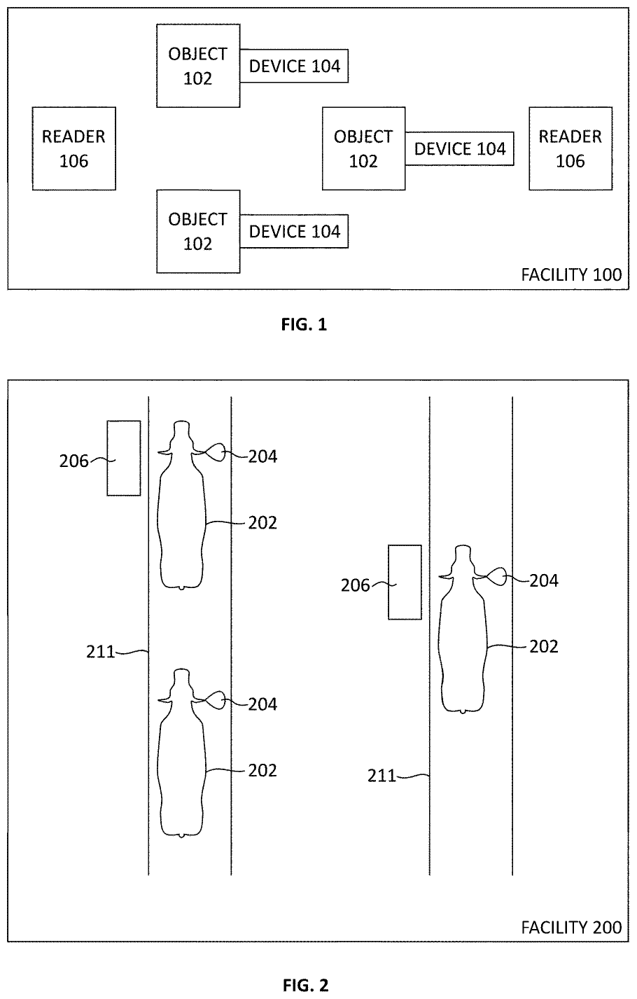

FIG. 1 shows an example electronic identification tag reader system.

FIG. 2 shows the system of FIG. 1 adapted for use in an animal facility.

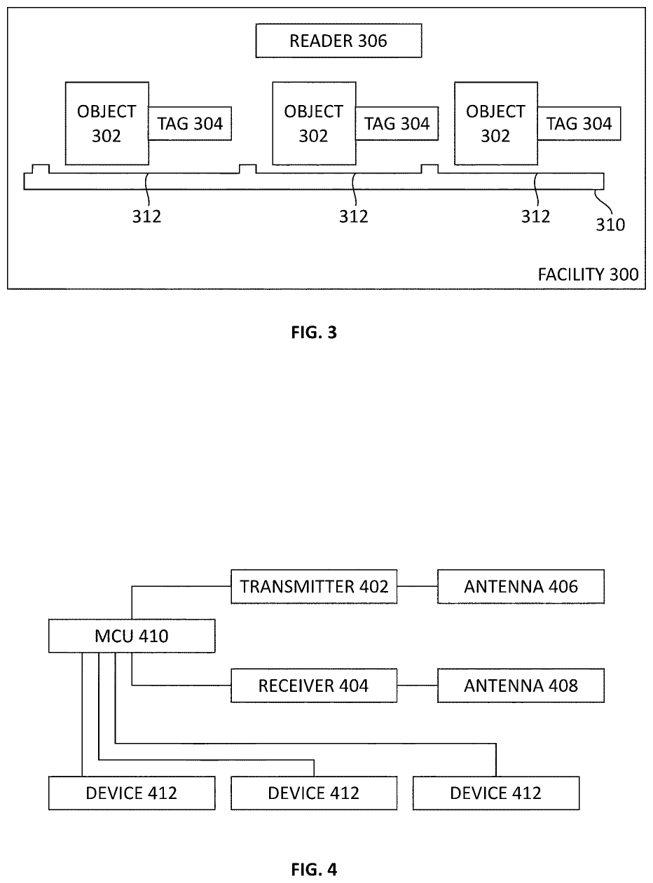

FIG. 3 shows the system of FIG. 1 adapted for use in conveyed objects.

FIG. 4 shows an example RFID reader.

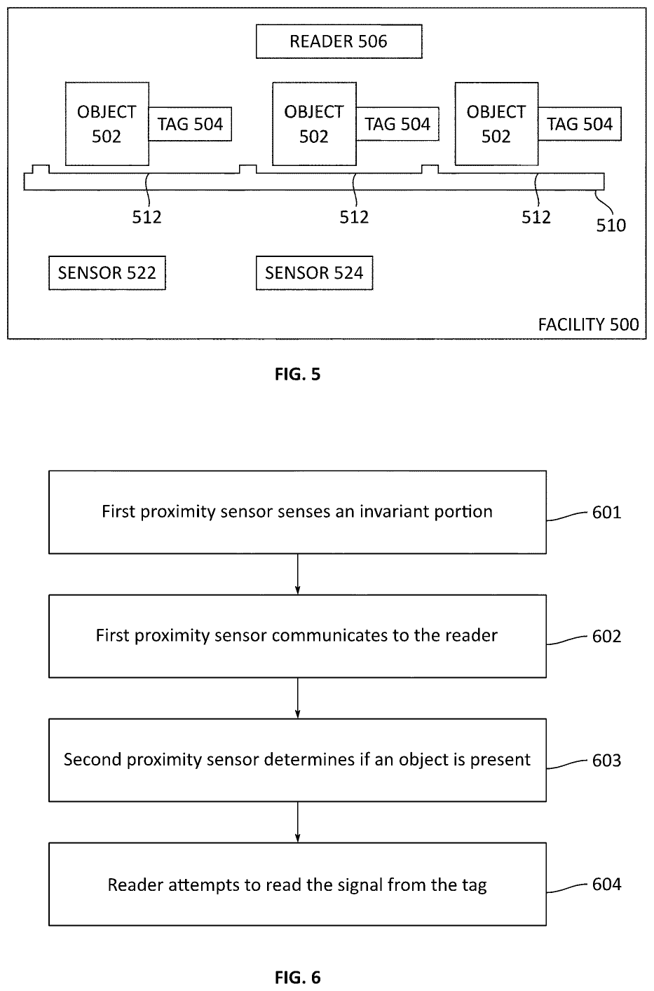

FIG. 5 shows the example reader system of FIG. 1 with proximity sensors.

FIG. 6 shows an example approach for operating the reader system of FIG. 5.

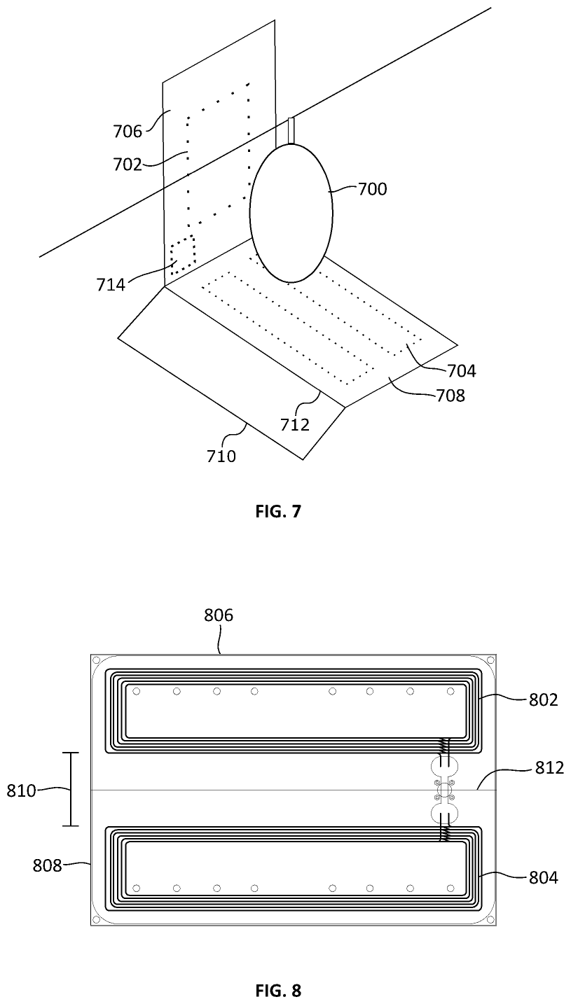

FIG. 7 shows an example antenna arrangement.

FIG. 8 shows an example receiver antenna.

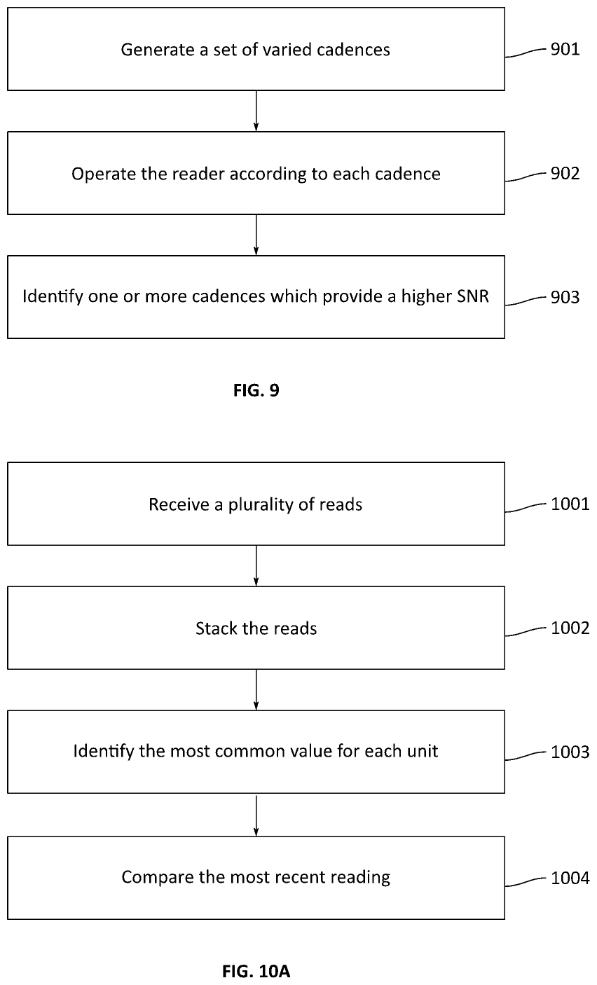

FIG. 9 shows an example digital signal processing approach.

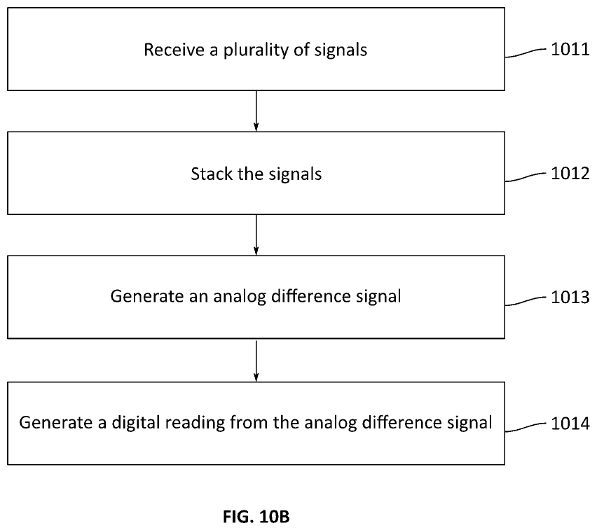

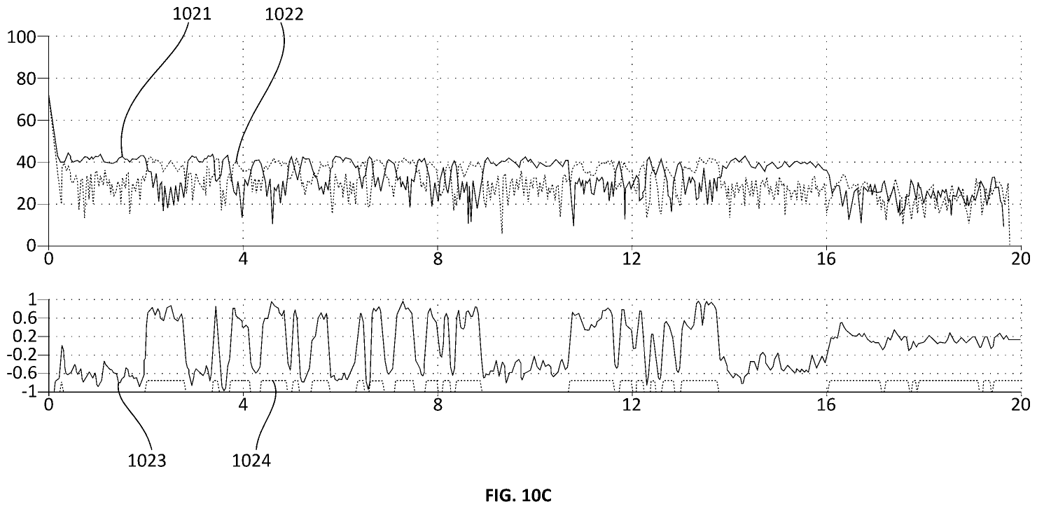

FIG. 10A shows an example approach for calculating an identifier based on digital readings.

FIG. 10B shows an example approach for calculating an identifier based on analog signals.

FIG. 10C shows an example graphical output that may be generated through the outputs of the approach of FIG. 10B.

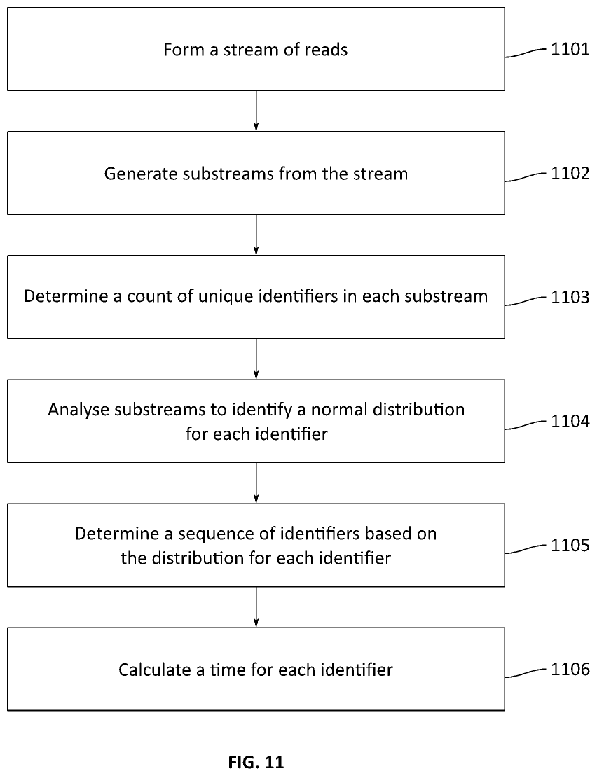

FIG. 11 shows an example approach for processing a stream of reads.

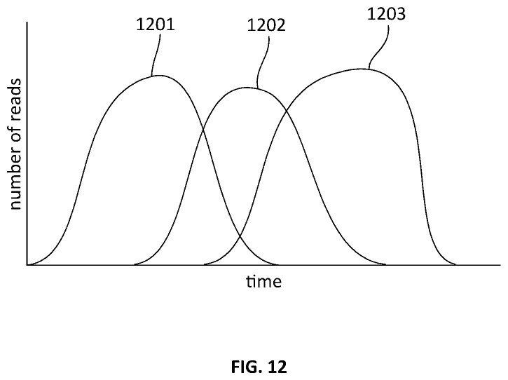

FIG. 12 shows an example graph of the number of reads of a set of tags with respect to time.

### DETAILED DESCRIPTION

The invention relates to improvements in electronic identification systems, including improvements in electronic reader systems. These will be set out with reference to a number of embodiments.

FIG. 1 shows an example embodiment which implements an electronic identification device reader system.

Facility 100 is a space configured for a function, and may be indoor or outdoor or some combination. The use of the term “facility” does not require any particular structure of physical arrangement and can include an open space.

Objects 102 travel through the facility. The travel may be constrained to paths that are defined by walls, conveyor belts, escalators, lane markings, gates, pathways, or any other means. Alternatively, the travel may be unconstrained through the facility, with the objects moving autonomously, being moved by a driver, or through any other means. Each object 102 comprises an electronic identification device 104 associated with the object 102. This may be attached to the object 102, embedded within the object 102, or co-located with the object 102. Each electronic identification device 104 stores an identifier for the corresponding object 102. The identifier is uniquely associated with the object. In this case, “uniquely” means unique relative to a group of objects, and not necessarily globally unique across all objects. For example, the identifier may be unique within a facility or group of facilities. In some cases, the identifier is globally unique such that it will not have been used on another identification device. The identification device may additionally or alternatively have visible indicia on a face of the identification device. For example, the identification device may visually display the identifier.

In some cases, the electronic identification device 104 may store further data. The further data may comprise object data relating to the object and/or device data relating to the electronic identification device.

The object data may comprise provenance (such as where the object came from, where the object has travelled, which other objects it has been close to), grading information (such as the type or quality of the object), ownership information (such as who owned or was involved in producing the object). In the case of an organic object (such as an animal), the object data may comprise biometric information (such as DNA sequences, or heredity information, temperature) or medical or health information (such as vaccinations, or health status).

The device data may comprise data about the electronic identification device 104, such as a manufacturing date, an owner identifier, a manufacturer identifier, a lot number, or a device identifier.

In some cases, the device data may comprise historical copies of the data. For example, if the stored data is updated, the electronic identification device 104 may retain the previous copy.

As each object 102 moves through the facility, a reader 106 is configured to read each electronic identification device 104. The reader system may additionally obtain the time at which the identifier was received. The read identifier (and optionally the time) may then be used (for example, in an analysis process or other process), transferred (for example, to another system), and/or stored in a data store.

The reader 106 and the electronic identification devices 104 use a common communication technology.

In one example, the electronic identification devices 104 are passive radio frequency identification (RFID) tags. In this case, a reader 106 sends an excitation signal to induce a current in the RFID tag, which results in each tag transmitting its identifier and/or part or all of its further stored data. This is received by the reader.

In a second example, the electronic identification tags 104 are active RFID tags. In this case, each tag 104 broadcasts a signal comprising its identifier and/or part or all of its further stored data. This can occur periodically or in response to a trigger. The broadcast signal is received by the reader.

In further examples, the technology may comprise one or more wireless communication technologies, such as Bluetooth (or Bluetooth Low Energy), WiFi (or WiFi Direct), Zigbee, Z-Wave, or Near Field Communication (NFC), and consequently the readers 106 and the identification devices 104 are provisioned to use such technology.

In some cases, the readers 106 and the identification devices 104 may be provisioned to use multiple technologies. In such cases, during an initial communication, the readers 106 and the identification devices 104 may select one to minimise errors in communication and/or minimise interference with other readers or identification devices.

A reader system, such as that shown in FIG. 1, can therefore be used to automatically track the movement and/or location of objects through a facility. This allows traceability and record keeping along a supply chain with minimal overhead. Such a reader system may be used in many applications, including without limitation slaughterhouses, abattoirs, feedlots, farms, barns, fields, pastures, paddocks, factories, warehouses, and mining facilities.

### Traceability

The reader system of FIG. 1 may be used in combination with other tracing systems, such as tracing systems configured to trace a set of objects where at least some of the objects move between a plurality of physically separate locations. In such a case, the reader system may be located at one or more of the physically separate locations. The reader system may obtain a reading of the given object's identification device uniquely identifying, the given object. This can be recorded as identifying the object being at the corresponding physical location.

As a result of the identification, a location change record may be generated using the unique identifier. The location change record includes an indication of an arrival time of the given member to the given location or the departure time of the given member from the given location, thereby enabling tracing the members throughout the process. The location change record includes an indication of an arrival time of the given object to the given location or the departure time of the given object from the given location, thereby enabling tracing the members throughout the process.

The location change record can then be sent to a data repository, indicating that the given object arrived at, or departed from, the distinct physically separate location, the location change record including an indication of an arrival time of the given member to the respective distinct physically separate location or the departure time of the given member from the respective distinct physically separate location, thereby enabling tracing the objects between locations.

### Reader System for Animal Facilities

FIG. 2 shows an example of how the reader system of FIG. 1 may be adapted for use in an animal facility (such as a feedlot, farm, barn, field, pasture, paddock, etc.), where the objects are live animals which, in at least part of the facility, move along paths. The paths may be at least partly defined by walls, gates, or other physical structures. Additionally or alternatively, the paths may be defined in use according to the expected behaviour of animals. For example, many animals (and in particular, herd animals such as sheep, cattle, or swine) tend to follow other animals in their group (such as the same herd, or animals with a companion or familial relationship). If a first animal moves in a certain direction (for example by being led by a worker) the other animals tend to approximately follow the path of the first animal. Consequently, a path may be defined by the first animal even without physical structures, or in combination with physical structures.

The example facility 200 of FIG. 2 comprises two paths 211, 212 along which the animals move. Although facility 200 is shown with two paths, a facility may have any number of paths in practice according to the preferred embodiment.

While this specific example shows the animals moving along paths, in other examples there may be no paths. For example, the animals may freely move through or about an area (such as a farm, barn, field, pasture, paddock, etc.) and pass by readers, as described below. In such cases, the example may be readily adapted accordingly to function without set paths.

The animals 202 each have an identification device in the form of an identification tag 204 associated with their bodies. Such a tag may be attached to the animal's ear, embedded in the animal's skin, fat, or muscle, sit within the animal's rumen, or is otherwise associated with the animal.

The identification tag 204 stores an identifier uniquely associated with the animal. In this case, “uniquely” means unique at least relative to a group of animals, and not necessarily unique across all animals worldwide, although this meaning is also included. A reader may interrogate the identification tag to obtain the stored identifier. The identification tag may additionally have visible indicia on a face of the tag. For example, the tag may visually display the identifier.

In some embodiments, there are multiple tags attached to the same animal. For example, these may be attached to each ear of the animal. This provides a level of redundancy in case one tag is damaged or becomes disconnected. Additionally, or alternatively, one or more further tags may be distributed across different parts of the animal. This can aid in identifying the parts of an animal when the animal is processed. Where an animal is provisioned with multiple tags, each tag preferably records the same identifier, but in some cases different tags on the same animal have different identifiers.

In use, the animals 202 pass by a reader 206. The reader 206 can be provided at any of one or more locations in the facility, which may include one or more of a race, a gate, a feeding area, a milking area, or checkpoints or locations that animals may pass or congregate near. The reader 206 is configured to obtain the stored identifier from the identification tag 204 of the animal 202. The reader 206 consequently receives the signal transmitted from the RFID tag. The reader 206 may then use the identifier (for example, in another process), transfer the identifier (for example, to another system), or store the identifier. The storage may be locally (for example, on a storage medium associated with the reader), remotely (for example, on a remote server accessible by the reader over a network such as the internet), or a combination of these. The reader 206 may additionally use, transfer, or store the time at which the identifier was received.

The reader system may comprise multiple readers uniformly or non-uniformly spaced along the paths. In general, at least one reader is provided on each path.

A reader system, such as that shown in FIG. 2, can therefore be used to automatically track the movement of animals through a facility. This allows traceability and record keeping along a supply chain with minimal human input.

### Reader System for Conveyed Objects

FIG. 3 shows an example of how the reader system of FIG. 1 may be adapted for use with non-live objects which are conveyed in a facility 300. This may be an abattoir where the objects are animal carcasses, in a factory where the objects are manufactured goods, in a mining facility where the objects are mined material, such as rocks, minerals, or ore, or any other style of facility. The paths are defined by the means of conveying the objects. For example, an abattoir may have paths defined by the paths of carcass hooks on belts, a factory may have paths defined by conveyor belts through the factory, and a mining facility may have paths defined by scoops, trucks, conveyors, or elevators.

The objects 302 each have an associated identification tag 304. The tag 304 may be attached, embedded, or co-located with the objects 302 depending on the nature of the object. The identification tag 304 stores an identifier uniquely associated with the object. A reader may interrogate the identification tag to obtain the stored identifier. The identification tag may additionally have visible indicia on a face of the tag. For example, the tag may visually display the identifier.

In the specific case of abattoirs, there may be multiple tags attached to the same animal. For example, these may be attached to each ear of the animal. This provided a level of redundancy in case one tag is damaged or becomes disconnected. Additionally, or alternatively, one or more further tags may be distributed across different parts of the animal. This can aid in identifying the parts of an animal when the animal is processed. For example, a tag may be attached to each leg of the animal so that the legs can be identified after being severed from the torso. Where an animal is provisioned with multiple tags, each tag records the same identifier.

The objects are conveyed by one or more conveyors 310, which may comprise conveyor belts, elevators, vehicles, hooks, ramps, escalators, drones, or any other means of conveying objects. While being conveyed, the objects 302 pass by a reader 306. The reader 306 is configured to obtain the stored identifier from the identification tag 304 of the object 302. The reader 306 consequently receives the signal broadcast from the RFID tag. The reader 206 may then use the identifier (for example, in another process), transfer the identifier (for example, to another system or within the same system), or store the identifier. The reader 306 may additionally use, transfer, or store the time at which the identifier was received.

In some cases, the conveyor 310 is divided into sections 312, where each section may (but does not necessarily) receive an object. Each section 312 of the conveyor 310 may be uniquely identified. For example, each section may have a similar identification tag to that of the object 302, or may have a barcode, QR code, or other visual or electronically readable identifier. In one example, each hook in an abattoir may have an identifier associated with it. In such cases, the reader system may further read the identifier associated with the section 312 in which the object 302 is located. The section identifier can then be used, transferred, or stored with the identifier of the object 302. This can further assist in tracing the movement of objects through the facility.

The reader system may comprise multiple readers uniformly or non-uniformly spaced throughout the facility, such as along the route of the objects (for example along conveyor 310). The route may be a single path between a starting point and an end point. Alternatively, the route may branch. In such cases, readers may be distributed on each part of the branched route to record the path of objects on each route.

A reader system, such as that shown in FIG. 3, can therefore be used to automatically track the movement of objects through a facility. This allows traceability and record keeping along a supply chain with minimal human input.

### Reader

In the example arrangements noted above, the reader is selected according to the communication technology intended for use between the reader and tags. FIG. 4 shows an example of one type of reader which is configured for use with RFID tags. This can be used as reader in the reader systems to read RFID identification tags associated with objects.

The RFID reader has a radio frequency (RF) transmitter 402 for transmitting a signal to an RFID identification tag and an RF receiver 404 for receiving a signal from an RFID identification tag. In this embodiment, the transmitter uses a dedicated transmitter antenna 406, and the receiver uses a dedicated receiver antenna 408. In other cases, alternative antennas may be used, such as a shared antenna between the transmitter 402 and the receiver 404. A microcontroller unit (MCU) 410 or other computing module is provided to control the transmitter 402 and the receiver 404. The reader may be attached to additional devices 412, such as a storage device to record identifiers received from RFID identification tags.

In some cases, the reader is configured to store data remotely, such as in the cloud. In such a case, the reader may transmit the data over a network (such as the Internet) to a remote server.

### Proximity Sensors

In some cases, one or more proximity sensors may be installed in a reader system, and particularly in a reader system for conveyed or moving objects. This can allow for the reader system (such as an MCU in the corresponding reader) to determine when an object is likely to be in proximity to the reader.

FIG. 5 depicts a modified version of the reader system of FIG. 3 in a facility 500 with the addition of two proximity sensors 522 and 524. The first sensor 522 is located upstream of the reader 506 such that an object 502 passes the first sensor 522 before it passes the reader 506. The first sensor 522 detects the presence of a predetermined part 512 of the conveyor 510 as it approaches the reader 506. For example, in the specific case of an abattoir, the first sensor 522 may detect the presence of a hook. This may be used to trigger a reader 506 to begin a transmission and signal read. Additionally or alternatively, the first sensor 522 may trigger the recording of a time at which the sensor was triggered. The second sensor 524 is located at or around the reader 506. The second sensor 524 detects the presence or absence of the object 502.

The first sensor 522 and second sensor 524 communicate with the reader 506 over a data link. This may be a wired or wireless data link. In the case of a wireless data link, the wireless data transfer approach is selected so as to avoid interference with the reader 506 communicating with tags 504. For example, the wireless data transfer may use a different wavelength, different communication protocol, or different encoding approach compared to the reader 506.

In one embodiment, the proximity sensors 522 and 524 are ultrasonic sensors. In a preferred embodiment the proximity sensors 522 and 524 are optical sensors which generally have longer detection range than ultrasonic sensors. The proximity sensor may additionally or alternatively be a weight sensor, heat sensor, visual sensor (such as a camera), or another kind of sensor configured to determine the proximity of an object to the reader.

Where a camera (or multiple cameras) is used, the camera may further be configured to read one or more visual marks or indicia. For example, if an identification tag comprises visual indicia for the identifier, the camera may be configured to read the visual indicia. This could be used to confirm the reading of the identifier from the electronic tag.

In some cases, the readings from one or more of the sensors may be input into a determination module, such as a computer programmed with an appropriate machine learning or artificial intelligence-based system. The determination module can then determine if an object is present on the basis of the sensor readings. Such a system may have been trained through providing training data to a neural network or other machine learning or artificial intelligence arrangement, where the training data maps sensor readings to object presence.

FIG. 6 shows an example approach for operating the reader 506 in combination with the proximity sensors 522 and 524.

At step 601, the first proximity sensor 522 senses the presence of a part of the conveyor (or other mechanism that is assisting in the movement of the objects) that does not vary substantially over time or with sample. For example, this may be a predetermined portion of the conveyor as it enters the detection range of the sensor 522. In some cases, the predetermined portion may be provided with features that are distinct from the conveyor, and the distinctiveness may depend on the type of sensor. For example, if the sensor is an optical sensor, the predetermined portions may be provided with optically distinct features, such as a reflective surface or a different colour. If the sensor is an ultrasonic sensor, the predetermined portion may have a more flat or solid surface compared to the conveyor).

In a first example, the conveyor may have walls to divide the conveyor into a series of divisions. In this case, the predetermined portion of the conveyer may be each wall (and more specifically, the predetermined portion for an object may be the wall that precedes that object.

In a second example, the conveyor may have a series of hooks (or other retainers) which hold the objects. In this case, the predetermined portion may be each hook.

In a third example, the predetermined portion may be a beacon or indicia at the start of a carriage (such as a scoops, trucks, conveyors, or elevators) holding the object.

Since the predetermined portions of the conveyor are known in advance, the first proximity sensor 522 can be expected to have a high accuracy. This is beneficial compared to sensing objects since objects my vary significantly from sample to sample.

In some alternative embodiments, the first proximity sensor 522 senses the presence of a consistent part of the objects that pass on the conveyor. In this case, the first proximity sensor 522 may operate in the same way but without sensing the presence of any part of the conveyor. In further embodiments, the first proximity sensor 522 may also operate by sensing a combination of a part of the conveyor and a part of the object.

For example, if the object is a carcass on a hook of the conveyor, the first proximity sensor 522 may sense the presence of a particular part of the carcass (such as the head, a lean tissue segment, or similar) and/or the hook. If the object is a boxed good travelling in a part of the conveyor defined by walls, the first proximity sensor 522 may sense the presence of an upper panel of the box and/or the walls.

At step 602, the first proximity sensor 522 communicates to the reader 506 that a predetermined portion of the conveyor (or the object, or a combination of the object and conveyor) is in proximity. In some cases, this causes the reader to prepare for a transmit-receive cycle. For example, this may cause the reader to begin the transmission of an interrogation signal immediately. Additionally or alternatively, the time of the first proximity sensor being triggered is recorded.

At step 603, the second proximity sensor 524 determines whether there is an object 502 at the predetermined portion of the conveyor. The output of this determination is stored for subsequent use. Additionally or alternatively, the second proximity sensor 524 may trigger the recording of a time at which the sensor was triggered.

At step 604, the reader 506 attempts to read the signal from the tag associated with the object. The outcome of the read is correlated with the output of the second proximity sensor 524.

If the read is successful and the second proximity sensor 524 indicates that there is an object present at the reader 506, the identifier in the read is stored in the manner noted above.

If the read is successful but the second proximity sensor 524 indicates that there is no object present, this indicates that the reader read a signal from an object other than the one located adjacent the reader. This may be recorded as a misread, and can then be discarded from processing. Alternatively, such a reading may be tentatively discarded only if the same identifier appears in a separate successful read.

If the read is unsuccessful but the second proximity sensor 304 indicates that there is an object present at the reader 506, this is indicative of a failed read. The conveyor 510 may be stopped until a successful read occurs. Additionally or alternatively, this may trigger an alert for a human operator to intervene. In a further alternative, the conveyor 510 may continue as long as the proportion of failed reads stays below a threshold. The operation in response to a failed read may be configured according to the level of precision required in record keeping.

If the read is unsuccessful and the second proximity sensor 524 indicates that there is no object present at the reader 506, this indicates that the read was correctly unsuccessful. This may be recorded as an empty conveyor. In some cases, the location on the conveyor may then be recorded, for example using a barcode, QR code, or other visual or electronically readable identifier to identify the particular part of the conveyor that is empty.

In some cases, a third (or further) sensors may also be provided to indicate different positions of the conveyor. For example, a third sensor may indicate that a particular part of the conveyor has left the read zone. This can provide a further data point to assist in determining the position of objects. This may be configured to determine the spacing of objects on the conveyor. If there is enough time or distance between objects, the reader may stop reading for the period between objects (that is, between when the third sensor determines that an object has left the read zone, and when the first sensor determines that a subsequent object is entering the read zone). This can reduce power usage, may decrease overall ambient noise, and may avoid incorrectly reading objects that are in close proximity on other paths.

This approach may repeat as each predetermined portion of the conveyor and each object 502 passes the reader. This can allow for multiple levels of checking, and consequently can ensure that the reader system operates at a high level of accuracy.

### Noise Cancelling Antenna

In some instances, the electrical distribution network and plant machinery near a reader system may result in electromagnetic interference (EMI) for the reader. It may be difficult or impossible for the reader to correctly read a tag's identifier if the ambient noise is strong relative to the signal strength. A high signal-to-noise ratio (SNR) is consequently beneficial for a high read success rate.

FIG. 7 shows an example antenna arrangement which reduces the effect of EMI and increases the SNR by minimising the distance between the tag and the reader. This can increase the SNR sufficient to overcome the EMI.

The transmitter antenna 702 and receiver antenna 704 are each housed in respective panel enclosures 706 and 708. The transmitter antenna 702 is arranged at an angle of about 45° to about 135°, or about 60° to about 1200, or about 75° to about 1050, or approximately perpendicular at about 90° to the receiver antenna 704. This contrasts with alternative arrangements which provide a transmitter antenna and receiver antenna that are substantially parallel.

The panel enclosures 706 and 708 are configured to minimally impede communication with the RFID tag. This occurs through selecting an appropriate material and construction for the panel enclosures 706 and 708 which does not interfere with the signal transmission. For example, materials such as plastic or wood may be used since they tend not to interfere with signals, and materials such as copper mesh or steel sheets may be avoided due to their conductivity and reflectivity.

The transmitter antenna 702 may be a single winding. The receiver antenna 704 may be twin windings wound counter-clockwise such that the windings are antiphase. In use, this antiphase twin windings have the effect of a virtual antiphase source local to the receiver (that is, functionally it is as if there is a separate source that is antiphase). Consequently, the EMI coupled into the receiver tends to be cancelled out through destructive interference between the signal and the antiphase signal. This allows the reading to be more easily received due to lower EMI. To ensure sufficient impedance matching at the interfaces between reader's receiver and transmitter modules and their respective antenna, an impedance matching circuit 714 may be employed and tuned according to the winding impedance specification.

The transmitter antenna 702 and the receiver antenna 704 do not interfere with each other. This is because the separate transmit phase and receive phase of the reader effectively time multiplexes the transmitter antenna 702 and the receiver antenna 704. That is, the reader antenna 704 is configured to read at periods at which the transmitter antenna 702 is not transmitting. Except in temporary, transient events, the field set up by the transmitter antenna consequently does not interfere with the field set up by the receiver antenna. Consequently, this avoids “null” or “dead” zones around the reader which might occur if the transmitter transmitted constantly: the magnitudes-larger transmission signal would swamp any signal received from the tags and therefore would prevent the receiver antenna 704 from receiving signals from the tags.

Alternatively, the receiver antenna 704 may receive consistently (including when the transmitter antenna 702 is transmitting), even though the signal received while the transmitter antenna 702 is transmitting is not a valid tag read. In this case, the receiver antenna 704 may be provided with a clamping circuit to ensure the signal received does not damage the receiver antenna 704 or other components. The signals received at the receiver antenna 704 while the transmitter antenna 702 is transmitting may then be filtered out while processing the signals to determine readings.

In the specific case of pendant objects, such as carcasses in an abattoir or hanging components in a factory, an additional slanting panel 710 may be adjoined to the edge 712 first encountered by objects (such as carcasses). The slanting panel 710's width and angle with respect to the panel 708 are such that the approaching object contacts the surface of the slanting panel 710 as opposed to the edge 712. This reduces the chance of the object 700 being damaged or becoming severed while passing through the reader.

FIG. 8 shows an example receiver antenna which further reduces the impact of EMI.

The twin windings 802 and 804 that make up the receiver antenna have identical shape and dimensions. In this case, “identical” means having electrical and mechanical properties (such as height, width, number of turns, and spacing) which differs by a functionally small amount. For example, they may differ by less than about 10%, or less than about 5%, or less than about 1%. In the illustrated example, each winding is generally rectangular in shape and composed of six turns. However, alternative shapes and a different number of turns are possible. The twin windings 802 and 804 are centre aligned along an axis 812 that traverses the two rectangles parallel to the edge 806 defining the width and perpendicular to the edge 808 defining the length dimension. The spacing 810 between the twin windings may be approximately the width of one of the twin windings.

In a preferred example, the width of each winding along the edge 806 may be in the range of approximately 500 mm to approximately 650 mm, or preferably approximately 560 mm. The length of each winding along the edge 608 may be in the range of approximately 100 mm to approximately 150 mm, or preferably approximately 125 mm. There may be provided a padding region of approximately 20 mm between the outer edges of the antenna and the edges of the housing.

More generally, the dimensions of different parts of the antenna may be scaled or adjusted depending on the read zone required. This may reflect the structure in which the antenna is to be installed. For example, in a race for livestock, the windings may be between around 800 mm and around 2400 mm, or between around 1000 mm and 1800 mm, or around 1200 mm high.

Each winding may be made from Litz wire, a PCB track, a solid strand conductor, or from another conductor type. Each winding may be wound using a winding machine or may be separately wound onto a former element which is then attached to a base. The base may be made of polyvinyl chloride (PVC), polyethylene (PE), polypropylene (PP), or another plastic with substantially similar properties. Alternatively, the base may be made from non-plastic materials, such as wood. The windings may then be secured using an elastomer compound such as silicone rubber, butyl rubber, nitrile rubber, or another appropriate material. A cover may be permanently or non-permanently bonded over the winding or windings to complete a rectangular panel enclosure for the antenna. The windings may terminate to an electrical connector that extends out of the panel to other parts of the reader.

Such an application may have a particularly beneficial arrangement for abattoirs. In such cases, the head of an animal (to which the tags may be attached) can be moved closer to the receiver antenna, and in some cases may slide along the panel in which the receiver antenna sits. However, this approach may be used in other settings, including in factories with pendant components.

### Digital Signal Processing

While the antenna arrangement described herein will reduce EMI, in some cases digital signal processing (DSP) may additionally or alternatively be used to improve SNR during reads.

FIG. 9 shows an example approach for performing such DSP.

In this case, DSP involves varying the cadence of the reader. The cadence is a transmit-receive cycle, and is characterised by the time length of the transmit phase proportional to the time length of the receive phase, along with the overall length of the cycle.

At step 901, the reader generates a set of varied cadences. These may be generated randomly or accordingly to a predetermined scheme. The variation of cadence period may be chosen to have a mean of zero so as to not affect the average read rate. That is, for a reader which is intended to have a read rate of x, the varied cadence periods may be x+1% and x−1%. This allows varied cadence periods without the average read rate of x changing. In embodiments where the varying cadence periods are randomly generated, the zero mean may be achieved by using a statistical distribution that has a mean of zero. The distribution may additionally be symmetric about the mean.

Additionally or alternatively, one of the varied cadences may be based on a mains frequency and/or one or more other frequencies. That is, mains electric power is generally supplied at a known frequency (such as 50 Hz or 60 Hz), depending on the location. In addition, there may be one or more other frequencies that are present in the environment surrounding the system (for example, due to the operation of machinery, lights, or similar). The cadence may therefore be intentionally unsynchronised with the mains frequency and/or the one or more other frequencies. This can avoid unexpected harmonics reducing the SNR.

At step 902, the reader operates according to each cadence in turn to obtain one or more readings. The one or more readings are stored as noted above, but are additionally stored in association with the cadence. The one or more readings may comprise a predetermined number of readings. This can ensure that each cadence is used for a comparable amount of time.

By disrupting the regularity of the cadence timing, this consequently disrupts the regularity of the read timing. That is, even if the initial cadence period is synchronised with the background noise (for example, has the same period or an integer multiple or fraction of the period), the varying cadence periods should not be synchronised in the same way (since the varying cadence periods are different from the initial cadence period). At one of the varying cadence periods, it may be found that the noise reduces in magnitude. The reads obtained using varied cadence periods may therefore have a higher SNR, improving the read's likelihood of success.

At step 903, the reader identifies one or more cadences which provide a higher SNR. This can be performed by obtaining the SNR for each cadence then comparing the SNR to determine which is the highest. The SNR may be calculated in any known approach. In one example, this occurs by comparing a theoretical signal which would be expected in the absence of noise to the signal received. In particular, the received signal is analysed to identify the different frequency components of the signal to produce a spectral decomposition. A Fourier representation of the expected signal may be obtained and subtracted from the spectral decomposition of the received signal. This would provide an approximation of the noise components, since the expected signal has been removed. An SNR may then be calculated by computing the ratio of a norm of the signal component to the same norm of the noise component. Once such a cadence has been identified, the reader may operate according to only that cadence rather than continuing to vary the cadence.

Additionally or alternatively, the reader may revert to step 901. This may occur after operating at the identified cadence for a period: the system may attempt to periodically recalibrate cadence to ensure it is operating optimally. This may additionally or alternatively occur when the SNR at the current cadence is below a threshold: the system may then attempt to find a better cadence. In this way, the system ensures optimal performance, even if interference sources change.

Through this approach, the SNR of reads may tend to increase without affecting the overall read rate. This improves the accuracy of the reader system without the need to slow down the throughput of objects passing the reader system.

In some embodiments, it may be possible to determine the periods of background noise through observing the interference of the background noises with different cadence periods. Consequently, this may be recorded and passed to a prediction module.

In an example, the prediction module determines a time, period, cycle, and/or other characteristics of the cadence period. This may reflect that the source of the background noise occurs on a regular or predictable schedule. The prediction module uses this determination to adjust the cadence.

In an example, the prediction module may be a computer programmed with an appropriate machine learning or artificial intelligence-based system. The prediction module can then determine the period of the background noise. Such a system may have been trained through providing training data to a neural network or other machine learning or artificial intelligence arrangement. Additionally or alternatively, the timing of the reading, such as the time of day or day of the week, may additionally be passed to the prediction module.

### Obtaining Readings

In one example, digital signal processing may be used to attempt to isolate signals from noise. Any algorithm or process which identifies signals at particular frequencies may be used. For example, algorithms that compute a discrete Fourier transform, such as the Fast Fourier transform algorithm, may be used for this purpose.

In some embodiments, the Fast Fourier transform may be used to compute a discrete Fourier transform. The Fast Fourier transform produces a more complete discrete Fourier transform for a broader spectrum. This may be desirable for embodiments in which further downstream signal processing requires complex spectral information, for example covering frequencies which are not known in advance.

In other embodiments, the Goertzel algorithm is used. Because there are relatively few known frequencies at which signals are transmitted to the reader (for example, one or two frequencies is common), the Goertzel algorithm may be more computationally efficient than a Fast Fourier transform. Consequently, using the Goertzel algorithm results in a high accuracy approach to obtaining readings at known frequencies despite noise with reduced computational overhead.

In particular, the Goertzel algorithm makes use of the signal received by the reader. The signal is sampled according to a sample rate (for example, the sample rate may be on the order of kHz, such as between about 1 kHz and about 64 kHz, or between about 8 kHz and about 32 kHz, or about 16 kHz). This results in a predetermined number of samples of the signal. These samples are taken as blocks of a predetermined size. A block is a sequence of samples. The block size may be more than about 8 samples, or more than about 32 samples, or more than about 96 samples). The block size and the sampling rate may be set based on computational and accuracy requirements. For example, where higher computational resources are available, the block size and/or the sampling rate may be increased, as this tends to result in a more accurate calculation. The values for block size and sampling rate can be set empirically for a given reader to optimize accuracy or may be preset.

Frequency coefficients are calculated for each of a set of predetermined frequencies for the block. The number of predetermined frequencies and the value for the frequencies is known from the tags being used. That is, each tag has one or more frequencies which it is configured to respond to. The set of frequencies therefore comprises each frequency used in the tags. The frequency coefficient is then calculated for the block using the discrete Fourier transform. This results in a coefficient for each predetermined frequency for the block. In some cases, where the coefficient is below a threshold, it may be recorded as zero.

As the result of the Goertzel algorithm, for each block, the components at each known frequency are computed. In general, these components will be non-negligible for a frequency when the reader has received a signal at that frequency. Typically, no more than one frequency has a non-negligible component for a given block. In some cases, all frequencies may have zero or negligible components for a block. In that case, the block could be considered to have no meaningful signal.

Through this process, each block will therefore yield a reading at one of the transmission frequencies. These readings can be concatenated to form a modulated stream. The stream is modulated according to a predetermined approach, such as an error-correcting code like the Reed-Solomon error correction codes. At this point, the stream can be demodulated by applying the inverse of the modulation scheme. This obtains the reading, such as the identifier. In some cases, one of a plurality of modulation schemes may have been used. In this case, the reader can attempt multiple such demodulation schemes until the correct one has been found. The correct demodulation scheme is generally identifiable through error detection, such as checksums.

The demodulated readings may then be further refined through post-processing methods described below.

Using the Goertzel algorithm therefore results in a high accuracy approach to obtaining readings at known frequencies despite noise with reduced computational overhead.

### Digital Stacking

Over time, the reader obtains multiple reads from a given tag. In perfect transmission, each read ought to comprise the same identifier. This is because a tag should transmit the same identifier each time.

However, in some cases, a read may be incomplete. This means that some parts of the identifier may not be transmitted correctly. This may result in some parts of the identifier being mis-transmitted (for example, as a different value) or may fail to be transmitted entirely. An incomplete read may occur due to interference or noise, or may occur for other reasons.

Over multiple reads, each transmission over the identifier may be incomplete, though may be incomplete for different reasons. For example, for an identifier:
<10101100>
   there may be four reads received:
<1010110_>
<10001100>
<10101111>
<_11201100>
   where _ indicates a value that was not successfully transmitted. In this case, none of the identifiers was correctly transmitted. Consequently, no single read may be taken to indicate an identifier.

Although in this example, the identifier is shown is an 8-bit identifier, in practical cases, the identifier may be other format. For example, the read may be digital, in which case the identifier may be any length (for example, 8-bit, 16-bit, 32-bit, or any other length), and may be any encoding (for example, binary, hexadecimal, ASCII, Unicode, or any other encoding). Alternatively, the read may be analogue, in which case the identifier is transmitted as a series of values at different frequencies.

In such cases, it is possible to calculate a correct identifier. FIG. 10A shows an example approach for doing so.

At step 1001, a plurality of reads is received. Each read comprises an identifier, and may comprise one or more further pieces of information (as described above).

The number of reads in the plurality of reads may be pre-determined. For example, the number of reads may be 2, 4, 8, 16, 32, or any other number. An increased number of reads may increase the accuracy, but may also require higher computational requirements. Consequently, the number of reads may be selected to balance these.

At step 1002, the reads are stacked. In this manner, each read is aligned, such that the start and end of each read occurs is aligned. Where each read comprises bits, characters, or other discrete units of data which each correspond to a sequence, the reads may be aligned so that the first unit of data of each read is grouped together.

In the example noted above, this may result in:
1 0 1 0 1 1 0
1 0 0 0 1 1 0 0
1 0 1 0 1 1 1 1
   1 1 1 1 1 0 0

At step 1003, the most common value for each unit is identified across the plurality of reads. These are concatenated to calculate an identifier as the result of a plurality of readings.

In the example above, this would result in:
<10101100>

This is the correct identifier, despite none of the readings being correct.

Step 1003 may be repeated for different numbers of readings. For example, step 1003 may be repeated for each of 2, 4, 8, 16 and 32 readings. Each calculation may provide a different identifier. However, in practice, the higher number of readings tend to result in a higher accuracy result.

At step 1004, the result (or results, where multiple numbers of readings are used) may be compared to a most recent reading. This may be the last reading in the plurality of readings received at step 1001.

This can indicate the accuracy of the reading. If the most recent reading is identical to a calculated reading, this indicates that the most recent reading is correct. Conversely, if the most recent reading is different from a calculated reading, or if multiple calculated readings are not aligned, this indicates a difficulty in transmission. Over time, this comparison may be used in diagnostics. For example, this may assist in identifying a faulty tag, a faulty reader, interference, or other issues that limit the accuracy of transmission.

This approach may be used for some or all reads. In some cases, this approach may be selectively used where an identifier has not been correctly transmitted. This may be indicated, for example, if a transmitted identifier does not satisfy a checksum or if a transmitted identifier is unexpected compared to the previous identifier. In such a case, the approach of FIG. 12 may be used to calculate the correct identifier. Alternatively, the approach may be used at all times. This results in a higher accuracy identifier calculation, despite any transmission difficulties.

In a preferred case, the method of FIG. 12 occurs substantially continuously. That is, each time a new read (or a number of new reads) is received, this may result in a new plurality of reads being received at step 1001. This may result in an overlap with the plurality of reads in a previous step 1001. In this way, the reader may continuously stack reads to provide a high accuracy calculation of identifier.

Where this approach is used, the reads may periodically be flushed. This may occur where a previous tag is known to have passed out of the field of the reader and/or a new tag is known to have entered the field of the reader. For example, these may use the proximity sensors of FIG. 5. This prevents reads that are known to relate to a first tag from being stacked with reads that are known to relate to a second tag, which might otherwise result in an incorrect identifier being calculated.

### Analog Stacking

FIG. 10B shows an example approach for calculating an identifier based on analog signals. FIG. 10C shows an example output which may be generated through the method of FIG. 10B.

At step 1011, a plurality of signals is received. Each signal encodes data, such as an identifier, and may comprise one or more further pieces of information (as described above). The encoding may be based on high and low frequencies. For example, each signal may comprise two frequencies, one corresponding to a high frequency and one corresponding to a low frequency. In one example, the high frequency may be 134 kHz and the low frequency may be 124 kHz. However, the two frequencies may be selected according to requirements.

At step 1012, the signals are stacked. In this manner, each signal is aligned, such that the start and end of each read occurs is aligned. The high values and low values of each signal are combined additively. This results in an aggregated high frequency signal 1021 and an aggregated low frequency signal 1022.

Different numbers of signals may be stacked. For example, each of the past 2, 4, 8, 16 and 32 signals may be combined. If the effect of combining the signals substantially maintains the same encoding as each constituent signal, this implies that all signals carry the same data. Conversely, if the effect of combining the signals results in a substantially different signal, this implies that the constituent signals do not match.

Consequently, for each of the numbers of signals being combined, this may result in a correlation calculation. The greater the number of signals that can be combined, the higher the correlation calculation, and therefore the more likely it is that the stacked signal accurately represents the most recently read tag.

At step 1013, the difference between the high frequency and low frequency over the length of the signal is calculated. These are aggregated over the stacked reads. This generates an analog signal difference 1023. The analog signal different has a positive value where the high frequency is received at a higher strength, and a negative value when the low frequency is received at a higher strength.

At step 1014, the analog signal difference 1023 is converted to a digital reading. This For example, a positive value may correspond to a 1 and a negative value may correspond to a 0. This digital signal may be used as a reading of the identifier of the tag.

This approach allows for multiple analog signals to be combined to produce a digital reading 1024. This results in a higher quality reading overall, and limits the effect of one or more false signals.

### Post-Processing Sort

In use, the reads from a reader from a stream. The stream comprises an ordered one-dimensional list of reads, each read related to one tag. Depending on the proximity of objects (and consequently the proximity of the tags), reads from different tags may be interlaced. For example, given three successive tags, t₁, t₂, and t₃ which pass a reader in order, the stream of reads may be:
[t₁ t₁ t₃ t₁ t₁ t₂ t₁ t₂ t₁ t₂ t₂ t₃ t₃ t₃ t₂]

Although this stream shows a small number of reads for illustrative purposes, in practice a stream may comprise tens or hundreds of reads for teach tag.

On receiving the stream, it might have been considered to directly calculate the order of the tags from the raw stream. If this were done, the reader might identify a subset (such as the middle) of the stream as indicative of the order.

For example, the seventh to ninth readings in the stream are:
[t₃ t₂ t₁]
   which would indicate that the tags are in the order t₃, t₂, and t₁.

However, this is a different order than the actual order of t₁, t₂, and t₃ in this example. Such an approach is therefore inappropriate when the tags are close, since the raw stream may be pseudo-random.

While one approach to mitigate this might be to space out the objects (and consequently their tags), this may in turn lead to a low throughput: the number of objects processed on a line is directly linked to the spacing between the objects.

FIG. 11 shows an alternative approach for calculating the order of tags from a stream. This is implemented as a post-processing method, that is, by a method that occurs after reads have been performed.

The input data for the method comprises a set of identifiers of tags which were read by the reader. The input data may additionally include the time of each read, or other information that records the sequence of the reads, such as numbering system or other sequence identifier. The set of identifiers may comprise tens, hundreds, or thousands of reads for each tag. The set can be all reads performed over a processing cycle of the reader (for example, over an hour, a few hours, a day, or any period of time).

At step 1101, a stream is formed. This occurs by ordering the identifiers by a sequence identifier of the corresponding read. Additionally or alternatively, the ordering may occur by time of the read or by another sequencing means. Consequently, the stream comprises an ordered one-dimensional list of reads.

At step 1102, substreams are generated from the stream. Each substream is a portion of the stream comprising successive readings, where neighbouring substreams may overlap. The size of each substream and the level of overlap between successive substreams can be adjusted according to accuracy and efficiency requirements. A greater overlap reflects higher frequency information, since this will show rapid variations in the composition of adjacent substreams. However, a greater overlap leads to a larger number of substreams for a stream, and consequently increases computation or storage requirements. The size of a substream may be based on the number of reads (such as about 32, about 64, or any other number) or based on the time over which the reads occurred. For example, each substream may correspond to a predetermined amount of time, such as about 1 second, about 2 seconds, about 10 seconds, or any other time period.

At step 1103, the count of unique identifiers in each substream is determined. This involves determining, for a given substream, the number of reads for each identifier in the substream. These are analysed irrespective of the time associated with the read. For each identifier tᵢ in the substream, there will be a corresponding count nᵢ corresponding to the number of successful reads of that identifier in the substream.

Thus, for an example substream:
[t₁ t₁ t₃ t₁ t₂ t₂]
   this will result be analysed as an unordered set of counts:
{n₁: 5, n₂: 2, n₃: 1}

At step 1104, the substreams are analysed to identify a normal distribution for each identifier. This uses the count nᵢ of each substream for each tag. It is expected that each identifier will, over a number of adjacent subsets, exhibit an approximately normal distribution. That is, the counts will first increase in a series of streams from close to zero, followed by a peak at which point that object constitutes the majority of the identifiers in that subset, and subsequently a decrease in its portion from the peak value to close to zero. For example, it may be observed from five adjacent substrings that identifier constitutes approximately 10% of the identifiers in the first subset, 40% in the second subset, 80% in the third subset, 40% in the fourth subset, and 10% in the fifth subset. Although this example demonstrates a substantial symmetry about the largest peak (i.e. 80%), other identifiers may or may not demonstrate such a symmetry.

At step 1105, the sequence of identifiers is determined based on the identified distributions. This occurs by ordering the distributions based on the peak of their distributions. This results in a sequence of identifiers. An example of this is shown in FIG. 12.

At step 1106, a time is calculated for each identifier. The time is calculated based on the time at the peak of each distribution. For example, this may be calculated as the time of the reading corresponding to the peak, or it may alternatively be the time of different clock, such as an internal computer clock or an external clock. Such a time may be taken as the time at which the object corresponding to the tag passes the reader. This may be recorded in a log with the identifier. In some cases, the time is not calculated (that is, step 1106 is omitted). This still allows the sequence of identifiers to be determined, but without a time associated with it. As a further example, both the time and the sequence of the peaks may be calculated in this step.

In some cases, the distributions identified at step 1104 may be used to generate a visualisation. Such a visualisation may display one or more of the distributions in a graph, where time is provided along one axis. Multiple distributions may be visually distinct, such as in different colour. The visualisation may be displayed to a user in a user interface, such as on a display.

Through this approach, the order of objects passing a reader may be determined by analysing the count of readings over time. Due to the high accuracy of this approach, this can allow a tighter spacing of objects on a line, and therefore can improve the throughput of a line without jeopardising reading accuracy.

In some cases (for example, an object having multiple tags), the system may read more tags than objects that have passed. For example, in a substream (corresponding to a single object), two tags may be nearly equally strongly read. These tags may not be read at any other time. This would indicate that two tags are attached to the same object.

Consequently, after the approach of FIG. 11, the system may further analyse the readings to determine any tags which are so strongly correlated as to likely be attached to the same object.

The system may then indicate these tags, for example with an alert, a user interface update, or other means.

In some cases, the received signal strength indicator (RSSI) (and/or one or more other characteristics of the received signal) may be used to determine the reliability of a reading. For example, the RSSI may be so high that there is no need to consider the distributions. This occurs because RSSI is typically proportional to the distance from the receiving antenna. If the RSSI is high, it is likely that the reading corresponds to a tag directly next to the antenna. Consequently, the system may determine that, where the RSSI of a reading is above a threshold, that reading may be preferred despite what the analysis might otherwise show.

In a more general case, RSSI (and/or one or more other characteristics of the received signal) may be used as part of a heuristic to determine a correct reading in combination with the distributions. For example, if the distribution indicates that either of two tags might be used, the one with a higher RSSI (and/or other characteristics) may be used to determine which is preferred. In a further example, each characteristic and the distributions may be weighted and combined to result in a single tag.

In some cases, the one or more characteristics and the distributions may be input into a determination module, such as a computer programmed with an appropriate machine learning or artificial intelligence-based system. The determination module can then determine the tag on the basis of all the inputs. Such a system may have been trained through providing training data to a neural network or other machine learning or artificial intelligence arrangement.

FIG. 12 shows an example of how the distributions for three sequential tags 1201, 1202, 1203 may appear when graphed as a number of readings with respect to time. It can be seen that the order of the peaks of each curve (corresponding to each tag 1201, 1202, 1203) matches the order of the tags. Consequently, even where the stream is pseudo-random, the approach described in FIG. 11, and herein, can nevertheless provide an accurate calculation of the order of tags.

### INTERPRETATION

Where a series of steps has been described, these steps need not necessarily be performed in the stated order (unless context requires otherwise). That is, steps may be performed out of order or in parallel in different embodiments.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A reader for an electronic identification tag, the reader comprising:
a transmitter antenna for exciting a passive electronic identification tag in proximity, the transmitter antenna comprising one or more windings; and
a receiver antenna for coupling a signal from the electronic identification tag to other parts of a receiver module, the antenna comprising twin windings wound in an anti-phase manner.

2. The reader of claim 1, wherein the transmitter antenna and the receiver antenna are positioned substantially perpendicular to one another.

3. The reader of claim 2, wherein the transmitter antenna and the receiver antenna are perpendicular within a tolerance of 5°.

4. The reader of m claim 1, wherein the twin windings are configured to cause a reduction of the interference coupled into the received antenna.

5. The reader of claim 1, wherein the transmitter antenna and/or the receiver antenna is enclosed in a panel.

6. (canceled)

7. The reader of claim 1, wherein the electronic identification tag is affixed to an animal, and the system used for animal identification.

8. A method for identifying a sequence of unique identifiers, each unique identifier being associated with an animal, the method comprising:
obtaining a stream of reads from animal identification tags, each animal identification tag being attached to a corresponding animal, each read comprising one of a plurality of unique identifiers;
identifying one or more distributions based on the number of reads for each of the plurality of unique identifiers in the stream; and
determining a sequence of unique identifiers based on the distributions.

9. The method of claim 8, further comprising:
generating one or more substreams from the stream, each substream comprising one or more successive reads.

10. The method of claim 9, wherein identifying one or more distributions based on the number of reads for each of the plurality of unique identifiers in the stream comprises:
identifying one or more distributions based on the number of reads for each of the plurality of unique identifiers in each substream.

11. The method of claim 8, wherein the stream of reads is pseudo-random and/or the distribution comprises a normal distribution.

12. (canceled)

13. The method of claim 8, wherein the distribution is substantially symmetric about a peak between a rise portion and a fall portion.

14. The method of claim 8, further comprising:
calculating a time for each unique identifier based on a peak of the distribution.

15. The method of claim 8, further comprising:
generating a visualisation corresponding to the one or more distributions.

16. A method for operating an animal identification tag reader, the method comprising:
determining, using a first sensor, that an animal bearer is approaching a reader; and
determining, using a second sensor near the reader, whether an animal is attached to the animal bearer.

17. The method of claim 16, further comprising, in response to determining, using a first sensor, that an animal bearer is approaching a reader:
attempting to read, using the reader, an identifier from an animal identification tag attached to the animal.

18. The method of claim 17, further comprising:
determining, using a second sensor near the reader, that an animal is not attached to the animal bearer; and
discarding a read from the reader.

19. The method of claim 17, further comprising:
determining, using a second sensor near the reader, that an animal is attached to the animal bearer; and
determining that the attempt to read failed and optionally in response to determining that the attempt to read failed:
stopping further progress of the animal bearer.

20. (canceled)

21. A method of operating an animal identification tag reader, the method comprising:
determining a plurality of cadences; and
reading one or more animal identification tags according to each of the plurality of cadences.

22. The method of claim 21, wherein determining a plurality of cadences comprises randomly determining a plurality of cadences.

23. The method of claim 21, wherein the net variation in the plurality of cadences relative to a predetermined cadence is approximately zero.

24. The method of any one of claim 21, wherein the plurality of cadences comprises a cadence calculated based on a mains frequency and/or the cadence calculated based on a mains frequency is not synchronised with the mains frequency.

25. (canceled)
